(19) United States
(12) Patent Application Publication
(10) Pub. No.: US 2018/0200746 A1
(43) Pub. Date: Jul. 19, 2018

(54) Indoor novelty water recycling system

(71) Applicants: Christopher David Palmby, Bellingham, WA (US); Janice J. Palmby, Deming, WA (US)

(72) Inventors: Christopher David Palmby, Bellingham, WA (US); Janice J. Palmby, Deming, WA (US)

(21) Appl. No.: 15/530,446

(22) Filed: Jan. 18, 2017

(51) Int. Cl. B05B 17/08; B05B 15/00

(52) U.S. Cl. CPC B05B 17/08; B05B 15/008

(57) ABSTRACT

A water recycling system having at the top under hose a metal plate (1), which filters water the hose dumps it out of. Near the base a metal plate (6) which filters same water into container (5). Circulating system that works by battery (4) and inter bilge pump inside drawer (5). Water is circulated to top of system. Four wood or plastic rods (7).

### BACKGROUND

### Field of Invention

This invention relates to a device used in a household that has a rainwater view coming down that is produced in machine.

### Description of Prior Art

Other water devices are commonly used in households such as running short streams.

### Objects and Advantages

Accordingly, besides the objects and advantages of a rain machine in a hosehold, several objects and advantages of the present invention are:

(a) to provide a machine with a battery, bilge pump, and hose.

(b) 2 metal plates for water to filter through.

(c) drawer for cleaning out machine on occasion.

(d) overall outside structure.

### DRAWING FIGURES

In the drawing, closely related figures have the same number but different alphabet suffixes.

FIG. 1 shows a side view of machine.

FIG. 2 shows a top view of metal plate.

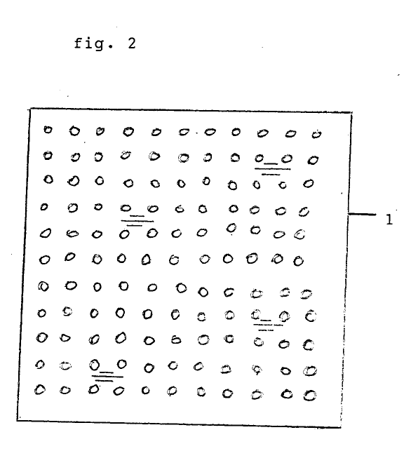

FIG. 3 shows a top view of metal plate.

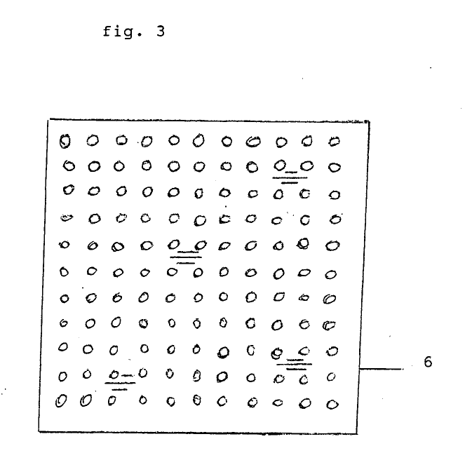

### Reference Numerals in Drawings

1) metal plate

2) bracket

3) hose

4) battery

5) drawer

6) metal plate

7) rod

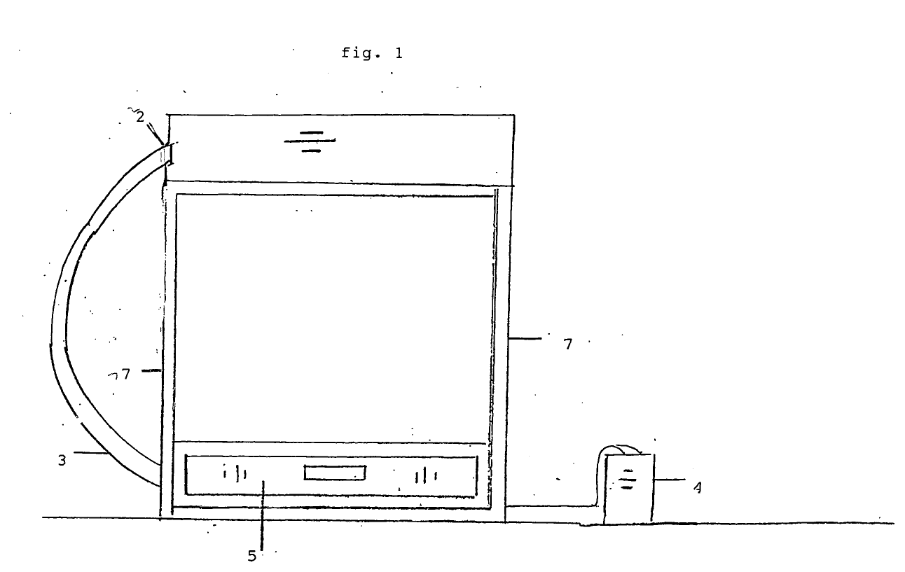

Description—FIG. 1

A typical embodiment of the rain machine of the present invention is illustrated in FIG. 1. The rain machine has such rods such as 7 to support it. The metal plates lay flat one at the top below hose and one on the bottom. Metal plate 1 makes the rain drops happen by water dripping through holes. Metal plate 6 is a plate that water filters through to drawer 5. A battery 4 supports a interior bilge pump a hose 3 extends up and recirculates water with by depositing water back into top.

Operation—FIG. 1

The manner of using the Indoor Novelty Water Recycling System to get it going is to make sure it is hooked up to the battery. Otherwise, the bilge pump won't operate. Water is poured at the top if the drawer is empty of water. One One doesn't want to add to much water otherwise the machine would flood over. The machine recycles water through the hose giving it a rotational motion.

Summary, ramifications, and scope.

Accordingly, the reader will see that the Indoor Novelty Water Recycling System of this invention can be used as visual entertainment.

Although the description above contains many specifications, these should not be construed as limiting the scope of the invention but as merely providing illustrations of some of the presently preferred embodiments of this invention.

Thus the scope of the invention should be determined by the appended claims and their legal equivalents, rather than by the examples given.

1) A machine, comprising
a. A structure supported by 4 rods having removable metal plate, water filters there under for water to deposit into.
b. a bilge pump in interior producing rotational action of water.

2) A method of recirculating water through a bilge pump at base and hose recirculating water in a revolving system.
